(19) United States
(12) Patent Application Publication
(10) Pub. No.: US 2018/0018032 A1
(43) Pub. Date: Jan. 18, 2018

(54) DIGITAL DISPLAY WITH MOBILE TRACKPAD

(71) Applicant: Will Glaser, Berkeley, CA (US)

(72) Inventor: Will Glaser, Berkeley, CA (US)

(21) Appl. No.: 15/209,567

(22) Filed: Jul. 13, 2016

(51) Int. Cl. G06F 3/0354; G06F 3/02; G06F 3/0346; G02B 27/01; G06F 3/0338; G06F 3/0484; G06T 19/00; G06F 1/16

(52) U.S. Cl. CPC G06F 3/03547; G06T 19/006; G06F 3/02; G06F 1/163; G06F 1/1654; G02B 27/0172; G06F 3/0338; G06F 3/04842; G06F 3/03549; G06F 3/0346; G02B 2027/0178; G02B 2027/0118; G02B 2027/0138; G02B 2027/014; G06F 2203/0331

(57) ABSTRACT

A display unit, in the form of a monocle or other very small display, provides visual input to a user based on data received from an input unit, such as a track pad. The display unit may provide a graphical user interface and is placed in front of a user's eye. The display unit has optics that allow data, documents, and information within the graphical user interface to be displayed for user viewing at very short distances. A user may provide input through the input unit remote from the monocle. The input unit may be held by the user in one hand, two hands, wrist-mounted, or in some other configuration.

### BACKGROUND

Computers have evolved a great deal over the last 20 years. Machines that once required an entire room full of equipment can now be implemented as a pocket, smart-phone. Advances in computer and manufacturing technologies have led to most households having some type of computer.

Currently, the size of a display screen and power capacity, which is usually provided by a battery, have stalled additional size reductions in household computers. For example, laptops and smart phones seem to be nearly as thin as possible, but are not reducing in length or width as result of the human need to read what's displayed on a computer screen. What's needed is an improvement in the computer that still enables a user to view and interact with a screen.

### SUMMARY

The present technology may include a display unit, such as for example in the form of a monocle or other very small display, and an input unit, such as for example a track pad. The display unit may provide a graphical user interface and may be placed in front of a user's eye. The display unit may have optics that allow data, documents, and information within the graphical user interface to be displayed for user viewing at very short distances, such as for example an inch or less away from the user's pupil. A user may provide input through the input device remote from the monocle. The input device may be a trackpad, trackball, joystick, or other suitable input device. The trackpad may be held by the user in one hand, two hands, or in some other configuration. In some instances, the trackpad may be placed in a user's pocket when not needed, only to be manipulated with a single hand to provide input and otherwise manipulate a display provided through the display unit. In some instances, the monocle and trackpad may be implemented in a variety of forms, such as for example as a removable face of a watch, with a trackpad implemented underneath a watch face.

Some implementations may include a system providing a display to a user. The system may include an input unit and a display unit. The input unit may receive input from a user. The input unit may include a first surface for receiving a touch input from a user and transmit data in response to the received input. The display unit may include a processor, memory, antenna and a display. The display unit may be remote from the input unit and be in communication with the input unit. The display unit may provide a graphical user interface through the display unit, wherein the graphical user interface is based on data received from the input. The display and graphical user interface may be configured to be viewed by a user at a distance of no more than 1 inch from the user's pupil.

Some implementations further include a second display on the reverse side of the display unit that is suitable for viewing at a greater distance from the eye, typically beyond five inches

Some implementations may include a method for providing a display to a user. A connection may be established between a display unit and a remote input unit. The display unit may provide a graphical user interface on a display on a first surface of the display unit, and the display and graphical user interface may be configured to be viewed by a user at a distance of no more than 1 inch from the user's pupil. Data may be received by the display unit from an input unit, wherein the data may be based on input received at the input unit. The display may be updated at the display unit based on the received data.

### BRIEF DESCRIPTION OF THE DRAWINGS

FIG. 1 illustrates a block diagram of an input unit and a display unit.

FIG. 2 illustrates a block diagram of an input unit.

FIG. 3 illustrates a block diagram of a display unit.

FIGS. 4A-C illustrate exemplary input units.

FIGS. 4 D-G illustrate exemplary input units with input portions.

FIGS. 5A-C illustrate exemplary display units.

FIGS. 6A-C illustrate exemplary wearable input units and output units.

FIG. 7 illustrates a method for using an input unit to provide input for a display unit.

### DETAILED DESCRIPTION

The present technology may include a display unit, such as for example in the form of a monocle or other very small display, and an input unit, such as for example a hand-held track pad. The display unit may provide a graphical user interface and may be placed over a user's eye. The display unit may have optics that allow data, documents, and information within the graphical user interface to be displayed for user viewing at very short distances, such as for example an inch or less away from the user's pupil. A user may provide input through the input device remote from the monocle. The trackpad may be held by the user in one hand, two hands, on a wrist strap, or in some other configuration. In some instances, the trackpad may be placed in a user's pocket or purse when not needed, only to be manipulated with a single hand to provide input and otherwise manipulate a display provided through the display unit.

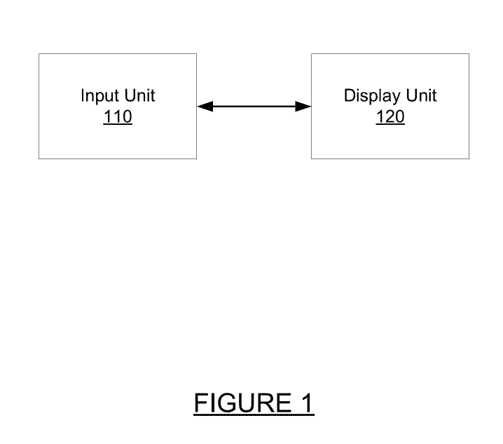

FIG. 1 illustrates a block diagram of an input unit and a display unit. Input unit 110 may receive input from a user and communicate with display unit 120. In FIG. 1, input unit 110 may include a variety of devices for receiving input, such as for example a trackpad, trackball, click buttons, and other devices. The input device may have a size suitable for holding in one hand. For example, an input device with a trackpad may be square, rectangular, circular, oval, or some other more ergonomic shape, with the track pad forming an upper surface of the device. An input device with a track pad may have a surface having an area that is no more than eight square inches. In some instances, the input device having a track pad surface may be approximately 2 to 3 inches long and 1 to 2 inches wide.

In some instances, different surfaces of the trackpad may receive different types of input. For example, a first surface having a trackpad may be suitable to receive a touch input, tap input, sliding input or gesture input, received when a user moves a finger, fingers, or thumb along the surface of the trackpad. Another surface of the trackpad, such as for example the opposing surface, may include one or more click button inputs that, when depressed or tapped, provide input that corresponds to a left mouse click, right mouse clicks, single click, double-click, shift-click, or some other input. In some implementations, different buttons may be located on the surface opposite to the trackpad or on adjacent side surfaces, or on the first surface but below the trackpad surface, allowing for manipulation by user without having to flip over the trackpad.

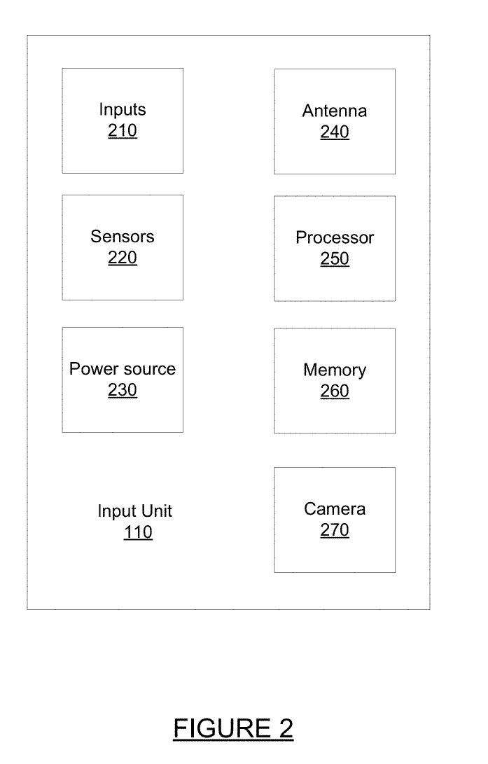

Input unit 110 is discussed in more detail with respect to FIG. 2.

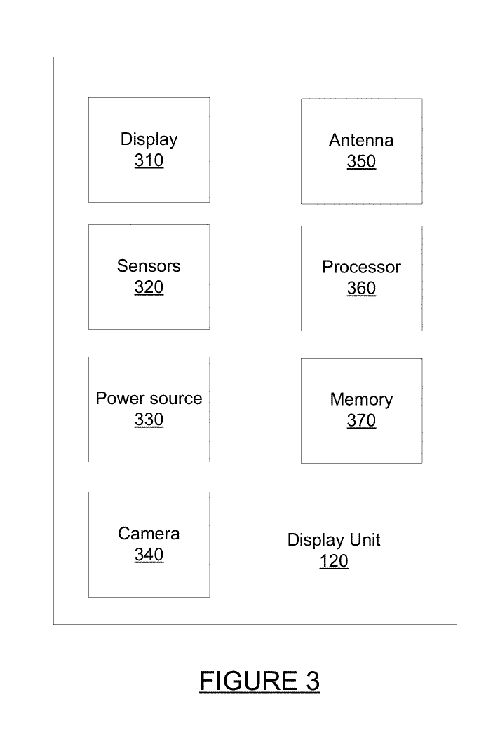

Display unit 120 may include a display for providing a graphical user interface. The graphical user interface may include representations of data, applications, and any other visual content typically output by a computer display. In some instances, the display unit may be implemented as a monocle and worn by the user within the user's eye socket. In other implementations, the display unit may be implemented using glasses or some other display device. Display unit 120 is discussed in more detail with respect to FIG. 3.

In some implementations, communication may occur in both directions between input unit 110 and display unit 120. Bi-directional communication may occur, as with Bluetooth; or the information might only flow from the input to the display, as is the case with some wireless devices such as a mouse device.

FIG. 2 illustrates a block diagram of an input unit. Input unit 110 of FIG. 2 includes inputs 210, sensors 220, power source 230, antenna 240, processor 250, memory 260, and camera 270. Inputs of input unit 110 may include one or more of a trackpad, trackball, joystick, clickable buttons, switches or sliders, or other input components. Sensors 220 may include accelerometers, gyroscope sensors, compass, motion sensors, direction sensors, and other sensors that may detect a current position and/or orientation of input unit 110. Power source 230 may include a battery or other source of power.

Antenna 240 may include one or more antennas and radios for transmitting, and maybe receiving, data with a remote device such as display unit 120. Processor 250 may receive data, execute logic to process the data, and provide an output or initiate an action. Memory 260 may include solid-state memory and other memory and can receive and store data. Each component of input unit 110 may be accessible to processor 250, including sensors 220, inputs 2210, antenna 240, and memory 260. Memory 260 stores, in part, instructions and data for execution by processor 250. Memory 260 can store executable code when in operation.

Input unit 110 may receive input at inputs 210, and process the input by processor 250 to generate one or more instructions or data to transmit to a remote device. Data may be transmitted via antenna 240.

In some instances, different types of input may be received by input unit 110 based on the position of input unit. For example, when sensors 220 detect a first surface facing upwards, input unit may receive positional data for a cursor through gestures and swipes of a user's finger or thumb, resulting in a cursor being moved around or selections being made at the point of the cursor within a graphical user interface provided by display unit 120. When a second surface of the input unit is detected to be facing up, the input unit may reverse the direction of received input, or receive input through a virtual keyboard, resulting in text being displayed on display unit 120. These reversal or conversion actions might take place on input unit 110 or on display unit 120; but in either case, the sense of left versus right on the surface of the trackpad is represented on the screen even when the surface is inverted.

Camera 270 may be implemented using any suitable camera known in the art that may be fit within the size and design of the input unit. The camera unit may operate with hardware and software to capture images and video.

In some implementations, the input unit may include a first surface that includes one or more a track pad, track ball, and a joy stick. The first surface, or other surface of the input unit, may include one or more selectable buttons which implement the first surface. For example, the entire surface of the trackpad can be implemented as a button, or may include one or more buttons on left side and right side, or more, or pushing the trackball or joystick can engage a button, and so forth. In some implementations, the first surface can be implemented as a shape that is neither a square nor a rectangle, such as for example an elliptical shape or other shape without any corners. In some implementations, the perimeter of the first surface can be compound curvilinear, with the compound curvilinear device fitting comfortably in the palm of a human hand during operation. The input unit can, in some implementations, have a shape that is not flat or rectangular. The input unit can, in some implementations, have a shape that is a compound three-dimensional shape designed so as to fit comfortably in the palm of a human hand during operation, such as for example a flattened small baguette-shape, wherein the first surface is flattened for the trackpad, or with a trackball paced into it.

In some implementations, the input unit can include a rounded, ergonomic, and substantially convex portion facing the palm, and flattened first surface facing outward for use as a trackpad. In some implementations, the input unit has a rounded, ergonomic, and substantially convex portion facing the palm, and first surface facing outward that present a joystick or trackball.

FIG. 3 illustrates a block diagram of a display unit. Display unit 120 may include display 310, sensors 320, power source 330, camera 340, antenna 350, processor 360, and memory 370. Display 310 may be implemented through optics that make a very small display look correspondingly big when viewed at short distances from a user's eye, such as for example at a distance of an inch or less from the user's eye. In some instances, display unit 120 may be worn as a monocle or otherwise very close to a user's eye. As such, the optics may include components that allow for up close display, and address anti-keystone and other distortions, and allow for small focus adjustment for users with near and farsightedness. In some instances, the optics allowing for close viewing of a virtually presented large-screen may include a display having greater than 250,000 pixels.

Sensors 320 may detect the orientation of display unit 120. For example, sensor 320 may include an accelerometer, gyroscope, compass, and other sensors that can detect a position, orientation, movement, and other aspects of display unit 120. Power source 330 may include a battery or other source of power for display unit 120. Camera 340 may include a camera that takes pictures outwardly away from a user of display unit 120, or may include multiple cameras to capture images in multiple directions. In some instances, the camera may be an outfacing camera. Antenna 350 may include one or more antennas, radios, and other circuitry components that can be used to send and receive data with a remote device such as input unit 110.

Processor 360 may include one or more processors, each of which may communicate with one or more of the display, sensors, power source, camera, antenna, and memory of the display unit 120, may receive and process data, and may output data. Memory 370 may store data, and may include solid-state memory and other memory. Memory 370 stores, in part, instructions and data for execution by processor 360. Memory 370 can store executable code when display unit 120 is in operation.

Display unit 120 may receive data, such as data to be displayed through display 310, for antenna 350. The received data may be stored in memory 370 and processed by processor 360. Processor 360 may process the data, generate display data and provide the display data to display 310. Aspects of display 310, such as data to be displayed, may be determined by data provided by sensors 320 and/or processor 360. The sensors 320 may indicate a relative position and/or orientation of display unit 120, such as whether a particular surfaces facing up or down.

Display unit 120 may have any of a variety of shapes, including an hour glass shape. The display unit may be two sided, wherein a first surface provides a first display for viewing at distances less than one inch and a second surface provides a second display for viewing at distances of between 6-18 inches, or over 18 inches from a user's pupil. The display unit may have a lens system to allow for user viewing at that close distance, when that lens system has a positive focal length. In some implementations, the display system can include a lens system has a focal length that is somewhat adjustable to allow for comfortable viewing by users with myopia or hyperopia. In some implementations, the display system can include optics that allow for a blending of the image generated by the display unit, and the physical world, thereby facilitating augmented reality (AR) applications, and/or allows for control over the degree of blending of the two images.

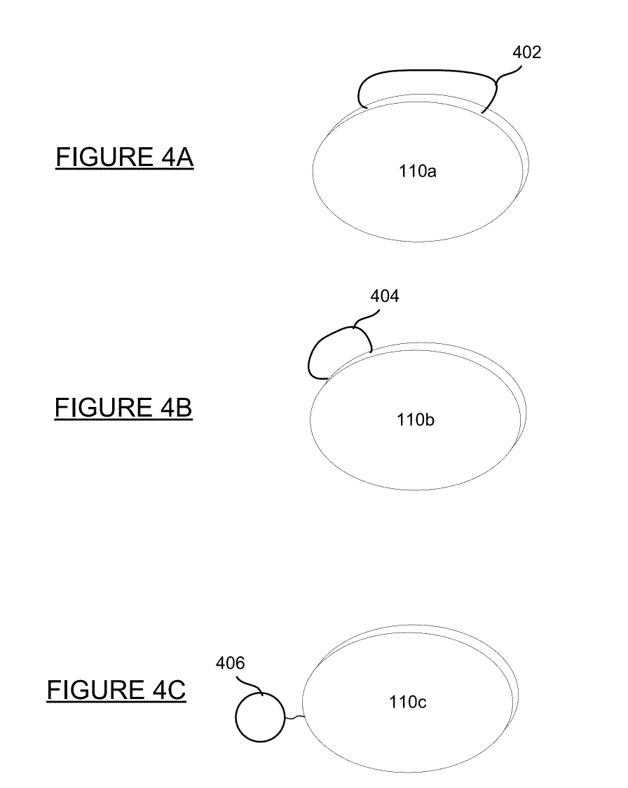

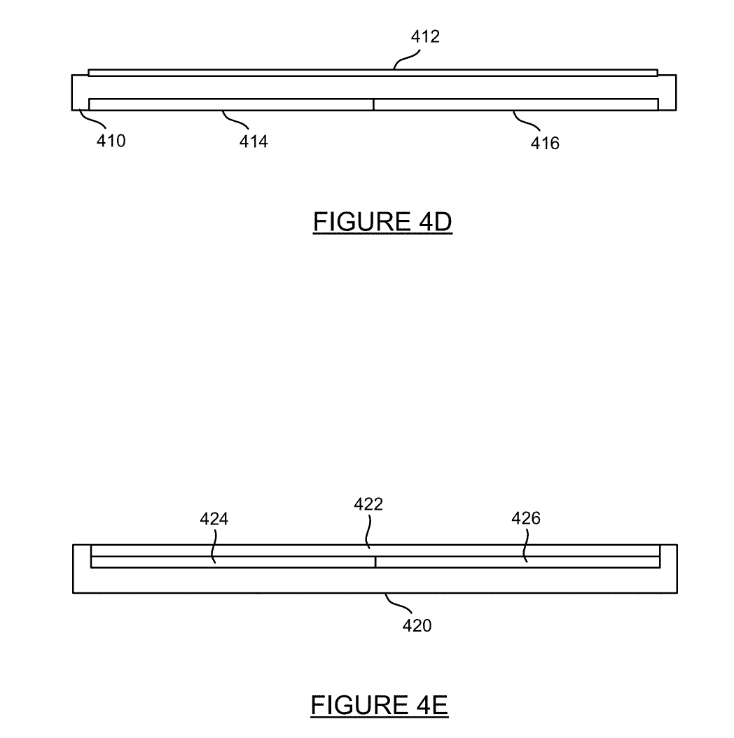

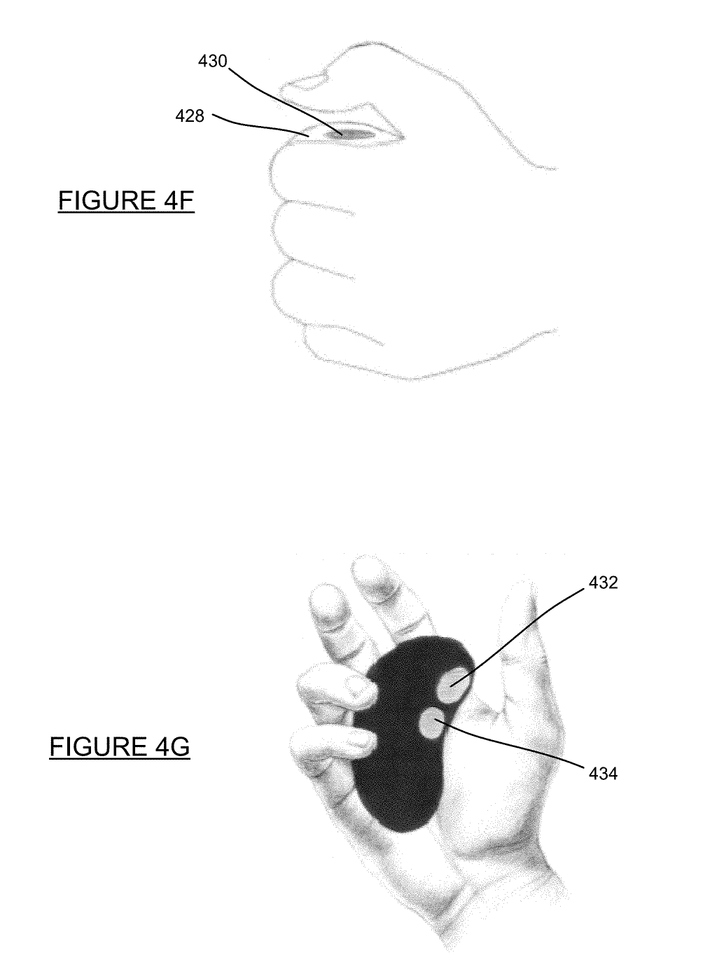

FIGS. 4A-C illustrate exemplary input units. Each of the input units in FIGS. 4A-C may be implemented with a strap, such as an elastic strap, Velcro strap, or other strap. The user may provide input to a surface of the input device (e.g., a track pad surface) using the one or more fingers or a thumb while the strap holds the input unit in the palm of the user's hand.

In FIG. 4A, the input unit 110a may be held by one or more fingers of a user using strap 402. The strap 402 may fit over one or more fingers of a user's hand to hold the trackpad in place in the palm of the user's hand. With one or more fingers passed through the strap, the input unit 110a could receive user input on a first surface from the one or more fingers while the track pad was securely positioned in the user's palm by the strap. A user could provide input to the opposite surface, a surface that may include one or more clickable buttons, using the user's thumb. Additionally, a user could provide input to either surface with the user's other hand.

In FIG. 4B, the input device 110b may be held in place using strap 404. Elastic strap 404 may receive a user's thumb to hold input device 110 be in the palm of the user's hand. The user may then provide input to a surface of input device 110b using the one or more fingers or a thumb. A user could provide input to the opposite surface, a surface that may include one or more clickable buttons, using the user's thumb. Additionally, a user could provide input to either surface with the user's other hand.

In FIG. 4C, the input device 110c may be held in place using ring 406. Ring 406 may receive a user's thumb or finger(s) to allow input device 110 to be held in the palm of the user's hand. The user may then provide input to a surface of input device 110c using the one or more of the user's fingers or the user's thumb. A user could provide input to the opposite surface, a surface that may include one or more clickable buttons, using the user's thumb. Additionally, a user could provide input to either surface with the user's other hand.

FIGS. 4 D-E illustrate exemplary input units with input components. The input unit 410 of FIG. 4D includes a trackpad surface 412 on one surface of input unit 410 and selectable buttons 414 and 416 on a second surface of input unit 410. The trackpad 412 may receive touch input, such as for example a swipe, slide, single finger touch, multiple finger touch, or any other touch input. Input device 410 receives the input through trackpad surface 412, and transmits the data to a display unit. The display unit may modify a graphical user interface provided by a display within display unit 120 to move a cursor, select an object, open a file, or perform some other task within the operating system that provides a display in response to the received trackpad input.

A user may depress buttons 414 or 416 to provide input that simulates a mouse left button click, right button click, or other input. In some implementations, input device 410 may transmit data to a display device in response to receiving inputs at button 414 or 416.

The input unit 420 of FIG. 4E includes a trackpad surface 422 positioned over input buttons 424 and 426. The trackpad 422 may receive touch input of a user, such as finger swipe or slide, a single finger touch, multiple finger touch, or any other touch input. Input device 420 may receive click button input through buttons 424 and 426, for example to provide input that represents a mouse left button click or right button click. In some implementations, input device 410 may transmit data to a display device in response to receiving inputs at track pad 422 and buttons 414 and 416.

FIG. 4F illustrates a trackpad 428 having an input surface 430 with less than one square inch. The trackpad surface may be engaged by a user's thumb, and may have additional inputs, such as for example clickable buttons, on a surface other than surface 430 and accessible by one or more fingers of the user.

FIG. 4G illustrates an input device having a non-flat shape or surface. In the input device of FIG. 4G, the active drawing area is convex and may be bulged upward. FIG. 4G includes an input surface 432 and a clickable button 434, both accessible by a user's thumb or finger. Other non-flat shapes and surfaces may be implemented within the scope of the present technology.

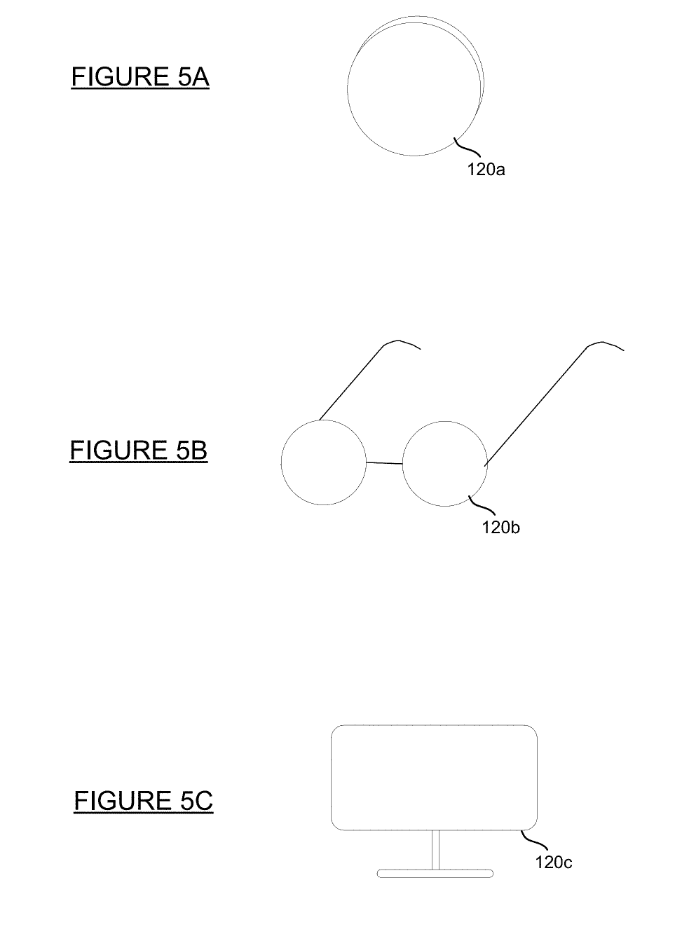

FIGS. 5A-C illustrate exemplary display units. A display unit of the present technology may be implemented in a variety of configurations. Display unit 120 of FIG. 5A is implemented as a monocle. The monocle may be designed to fit in place over a user's eye, and may include one or more galleries or extensions from the monocle that help position the monocle in place over the eye. A display device implemented as a monocle as shown in FIG. 5A may include the display unit components discussed with respect to FIG. 3, including a processor, memory, antenna, and other components, which may be implemented individually or on an integrated circuit, and a display implemented on a monocle surface that faces the user's eye.

Display unit 120 be of FIG. 5B is implemented as a pair of glasses. In this implementation, one or more of the lenses of the glasses may implement as the input device. When implement it as glasses, any part of the glasses may include the components discussed with respect to the display unit 120 of FIG. 3.

In order for the main display to be viewed close up, such as for example less than one inch from the user's eye, a convex lens may be positioned between the eye and the display. A small convex lens makes the very small and close image look large, and comfortably far away for viewing. The display is actually small, for example when compared to a traditional computer screen, but appears as a big-screen TV for comfortable viewing.

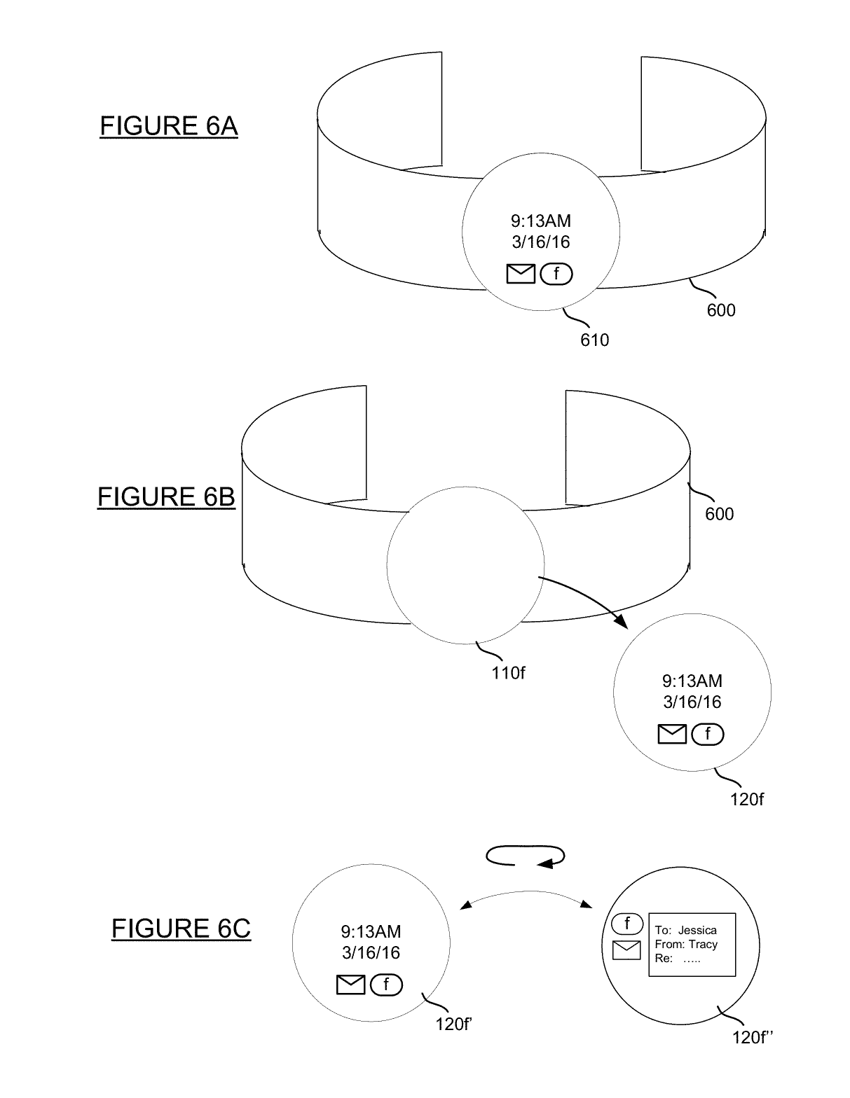

In the case of a “pocket-watch” type implementation, the present technology can implement a display “on the surface” of one side of a component (See FIG. 6C). In other words, one side can be held up close to a user's eye for a high-res display using a lens, while the reverse side is a more standard resolution screen that is suitable for viewing at a distance without any lens, such as for example a wearable watch screen. This second display can provide a watch face or similarly less pixel-intensive information.

In some implementations, displaying a 120 may include a larger display, such as a desktop display 120c. In this implementation, an input device may be paired with the desktop display through a wireless communication protocol, such as a Bluetooth protocol or other wireless communication protocol.

In some implementations, display 120 may include a hand-held display, such as a smartphone. In this implementation, an input device may be paired with the display through a wireless communication protocol, such as a Bluetooth protocol or other wireless communication protocol

FIGS. 6A-C illustrate a system that includes an input unit and display unit incorporated into a wearable device. The input unit and output unit of FIGS. 6A-C are integrated into a wearable device worn on a user's wrist. A strap 600 may fit over a user's wrist. The strap may be a firm plastic material or other material that holds its shape and position on the user's wrist, or may include a buckle, Velcro, or other securing mechanism to keep the wearable device and position. An input unit 110f may be coupled to the strap. A display unit 610 may be coupled to band 600. The display unit may provide a graphical and textual display to enable the display unit to be used as a watch while attached to the strap 600.

The display unit can be removably coupled to the strap, such that the display unit can be removed and re-attached to the strap, as shown in FIG. 6B, thereby revealing a structure 110f. When removed, the structure 110f attached to band 600 may be used as a trackpad that implements an input device. A user may provide input to input device 110 F to manipulate a display provided by display unit 120f, which may be worn as a monocle by the user. In some implementations, input received in a first direction on the input unit provides for an action associated with a second direction on the display unit, the first direction and the second direction being opposite directions

The display unit may have sensors that detect a position of display unit 120, as well as whether the display unit is attached to structure 110f. In some implementations, when the sensors detect that unit 120f is attached to structure 110f, the display unit may provide a display that resembles a smart watch. When the sensors detect that unit 120 F is not attached to structure 110, the display unit may provide a display suitable for use as a monocle positioned at close range in front of the user's eye.

In some implementations, the display unit may have optics and/or a display on either side of the display unit. For example, the display unit may have a first side 120f′ that may operate as a smart watch display. The other surface of the display unit may provide a display suitable for use as a monocle, including a magnifying lens, when the display unit is positioned close to a user's eye.

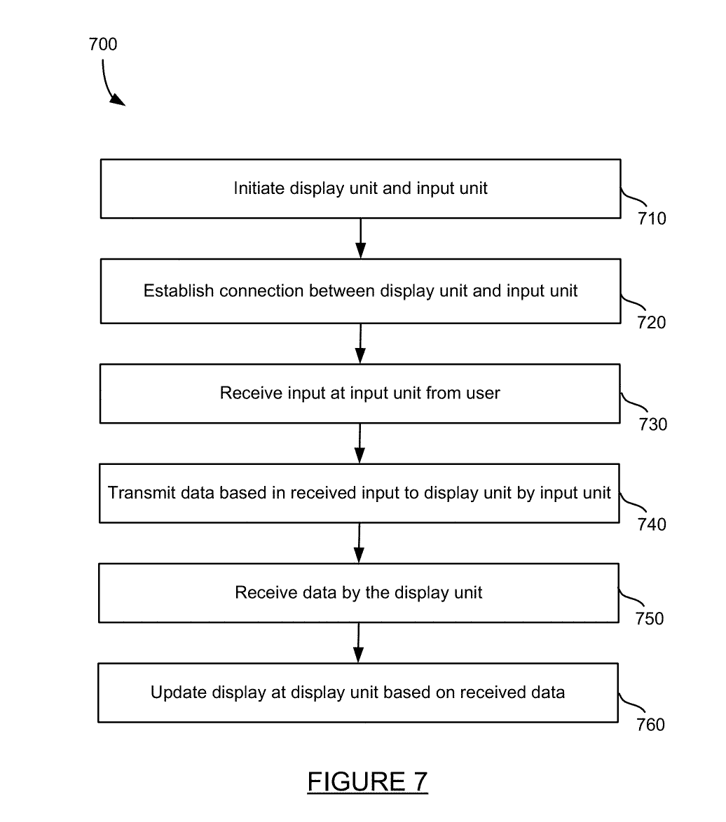

FIG. 7 illustrates a method for using an input unit to provide input for a display unit. A display unit and input unit may be initiated at step 710. Initiating the display unit and input unit may include powering on each unit, such as for example with a switch, a shake, or a button.

A connection may be established between the display unit and the input unit at step 720. The connection may be formed automatically after initial pairing is completed. The pairing and subsequent connections may be performed based on a wireless communication protocol, such as for example a Bluetooth protocol or other suitable wired or wireless pairing protocol. In the case of one-way transmission from input device to display device, no connection need be established. In the case of bidirectional communication (such as for example a “Bluetooth” wireless connection), a connection step is required. In the case of one-way transmission, it might be that first transmission that triggers the initiation.

Input may be received at the input unit from a user at step 730. The input may include input received on a trackpad, a selection of a clickable button, or a combination of inputs.

Data is transmitted based on the received input to the display at step 740. The data is generated based on the received input and transmitted by the input unit as soon as input is received. The data may indicate the type of input received, such a swipe from a first coordinate to another coordinate on a trackpad, a single coordinate on the track pad, a state of a clickable button, or other data that communicates the input received at an input device. In this manner, the display of the display unit may be changed based on input received at the remote input unit.

The input may be received at the display unit at step 750. The display at the display unit is updated based on the received data at step 760. The display may be changed to move a cursor, select a file for opening, or any other screen update based on the input received. Updating the display may include receiving the input, determining an operation to perform based on the input, including updating a graphical user interface provided by the display unit, and performing the operation.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for providing a display to a user, comprising:
an input unit for receiving input from a user, the input unit being a hand held device and having a first surface for receiving a touch input from a user, the input unit transmitting data in response to the received input; and
a display unit including a processor, memory, antenna and a display, the display unit remote from the input unit and in communication with the input unit, the display unit providing a graphical user interface through the display on a first surface of the display unit, the graphical user interface based on data received from the input, the display and graphical user interface configured to be viewed by a user at a distance of no more than approximately 1 inch from the user's pupil.

2. The system of claim 1, the input unit including a track pad on the first surface.

3. The system of claim 1, the input unit including a track ball on the first surface.

4. The system of claim 1, the input unit including a joystick on the first surface.

5. The system of claim 1, wherein the input unit includes selectable buttons.

6. The system of claim 5, wherein the selectable buttons are on the first surface of the input unit.

7. The system of claim 5, wherein the selectable buttons are on a second surface of the input unit.

8. The system of claim 5, wherein the first surface implements the selectable buttons, the selectable buttons surface including the first surface.

9. The system of claim 1, wherein the first surface has an area of less than eight square inches.

10. The system of claim 1, wherein the first surface is has neither a square shape nor a rectangular shape

11. The system of claim 10, wherein the first surface is substantially elliptical shaped.

12. The system of claim 10, wherein the perimeter of the first surface is compound curvilinear, the compound curvilinear system fitting comfortably in the palm of a human hand during operation.

13. The system of claim 10, wherein the input unit has a depth of less than one third of an inch.

14. The system of claim 1, wherein the input unit is not flat.

15. The system of claim 1, wherein the input unit has a rounded, ergonomic, and substantially convex portion facing a palm of a user of the system, and flattened surface facing outward for use as a trackpad.

16. The system of claim 1, wherein the input unit has a rounded, ergonomic, and substantially convex portion facing the palm of a user, and first surface facing outward that present a joystick or trackball.

17. The system of claim 1, wherein the input unit includes a strap to be worn around at least one finger or thumb of a user.

18. The system of claim 1, wherein the display unit includes an outward facing camera.

19. The system of claim 1, wherein the input unit includes a camera.

20. The system of claim 1, wherein the input unit includes at least one motion sensor.

21. The system of claim 1, wherein the input unit includes at least one direction sensor.

22. The system of claim 1, wherein the display unit has a shape of a monocle.

23. The system of claim 1, wherein the display unit has a shape of eyeglasses.

24. The system of claim 1, wherein the first surface has an area of less than 1 square inch.

25. The system of claim 1, wherein the input unit has a shape of a handheld smartphone.

26. The system of claim 1, wherein the display unit includes a second display on a second surface, the first surface opposite from the second surface, the second display configured to be viewed by a user at a distance of at least 6 inches from the user's pupil.

27. The system of claim 1, wherein the display unit includes a second display on a second surface, the first surface opposite from the second surface, the second display configured to be viewed by a user at a comfortable reading distance.

28. The system of claim 1, wherein the display unit includes a lens system to allow for user viewing at that close distance, wherein that lens system has a positive focal length.

29. The system of claim 28, wherein the lens system has a focal length that is somewhat adjustable to allow for comfortable viewing by users with myopia or hyperopia.

30. The system of claim 29, wherein the optical system allows for a blending of the image generated by the display unit, and the physical world, thereby facilitating augmented reality (AR) applications.

31. The system of claim 30, wherein the optical system allows for control over the degree of blending of the two images.

32. The system of claim 1, wherein the input received at the input unit causes a cursor to be moved in the graphical user interface provided by the display unit.

33. The system of claim 1, wherein the input received at the input unit causes an object to be selected in the graphical user interface provided by the display unit.

34. The system of claim 1, further comprising a band configured to be worn around the user's wrist, the input unit coupled to the band.

35. The system of claim 1, the display unit removably coupled to the input unit.

36. The system of claim 1, wherein input received in a first direction on the input unit provides for an action associated with a second direction on the display unit, the first direction and the second direction being opposite directions.

37. The system of claim 36, wherein only a left and right direction is reversed.

37. The system of claim 1, wherein the display unit alters the content of its display as a result of a sensor that indicates it is docked or not docked to the input unit.

38. The system of claim 1, wherein input unit and display unit are implemented in a wrist-worn system, wherein the display unit changes display in response to the input unit being removed from the wrist.

39. The system of claim 1, wherein the trackpad be operated by fingers on one hand of a user and buttons may be operated by fingers of the user's other hand.

40. A system for providing a display to a user, comprising:
an input unit for receiving input from a user, the input unit having a first surface for receiving a touch input from a user, the input unit communicatively coupled with a computing device,
a display unit communicatively coupled to the computing device, the display unit remote from the input unit and the computing device and in communication with the input unit, the display unit providing a graphical user interface through the display on a first surface of the display unit, the graphical user interface based on data received from the input, the display and graphical user interface configured to be viewed by a user at a distance of no more than 1 inch from the user's pupil.

41. The system of claim 40, wherein the display unit is a monocle.

42. The system of claim 40, wherein the input first surface is less than eight square inches.

43. The system of claim 40, wherein the input unit is coupled to a strap configured to be worn by a user.

44. The system of claim 40, wherein the computing device has a length of less than five inches, a width of less than three inches, and a depth of less than 0.5 inches.

45. A system for providing a display to a user, comprising:
a mobile device including a processor, memory, antenna, and a touch surface input,
an application stored in memory of the mobile device and executable by the processor, the executing application receiving input from a user through the touch surface, the input unit transmitting data in response to the received input; and
a display unit remote from the mobile device and in communication with the mobile device, the display unit providing a graphical user interface through the display on a first surface of the display unit, the graphical user interface based on data received from the input, the display and graphical user interface configured to be viewed by a user at a distance of no more than 1 inch from the user's pupil.

46. A method for providing a display to a user, comprising:
providing display data to a display unit from a remote input unit, the display data including graphical user interface data to display for a user, the display and graphical user interface configured to be viewed by a user at a distance of no more than 1 inch from the user's pupil, wherein the input unit includes a first surface having a surface area of less than eight square inches; and
updating the display at the display unit based on the received data.

47. The method of claim 46, further comprising establishing a connection between a display unit and a remote input unit.

48. The method of claim 46, wherein the graphical user interface data is displayed on a first surface of the display unit.
